(19) United States
(12) Patent Application Publication
(10) Pub. No.: US 2023/0135905 A1
(43) Pub. Date: May 4, 2023

(54) MACHINING TOOL WITH HIGH PRECISION MACHINING CAPABILITY

(71) Applicant: P&L GMBH & CO. KG, Soltau (DE)

(72) Inventors: Jürgen RÖDERS, Soltau (DE); Silke COHRS, Soltau (DE)

(21) Appl. No.: 17/915,283

(22) PCT Filed: Feb. 24, 2021
(86) PCT No.: PCT/EP2021/054535

§ 371 Date: Sep. 28, 2022

(30) Foreign Application Priority Data
Apr. 1, 2020 (DE) 10 2020 204 232.2

(51) Int. Cl. B23Q 15/18; B23Q 15/12; B23Q 17/09

(52) U.S. Cl. CPC B23Q 15/18; B23Q 15/12; B23Q 17/0985; B23Q 17/0923; B23Q 3/15553

(57) ABSTRACT

The invention relates to a machining tool for machining a workpiece, including a main spindle with a driven shank, a tool holder which can be clamped in the shank, a cutting tool which is arranged on the tool holder, a distance sensor for determining a distance of the shank of the main spindle in relation to a reference point, and a control unit which is configured to perform compensation of the tool path during machining of the workpiece based on an elongation and displacement of the shank and an elongation of the tool holder holding the cutting tool, wherein the elongation and displacement of the shank is determined based on the distance determined using the distance sensor, and wherein the elongation of the tool holder holding the cutting tool is determined based on a rotational speed of the shank.

The present invention relates to a machining tool with high-precision machining capability for machining a workpiece, in which elongations of components of the machining tool caused by thermal and/or rotational speed can be detected and incorporated into machining control. Furthermore, the present invention relates to a method for operating a machining tool.

Machining tools for machining are known from prior art in various embodiments. For a milling or grinding operation, a cutting tool is usually clamped to a main spindle. For this purpose, the cutting tool is usually mounted in a tool holder. The tool holder with cutting tool is clamped to the shank of the main spindle using a standardized interface, e.g. hollow shank taper or steep taper. The main spindle drives the shank with the tool holder and cutting tool clamped thereto to mechanically work on a workpiece in the machining tool and sets it in rotation. The shank is supported in the main spindle by means of ball bearings. However, other forms of bearings, e.g. hydrostatic or aerostatic, are also known.

Before starting machining with a newly clamped-in tool holder with cutting tool, determination of the length of the cutting tool is usually performed on the main spindle. A measuring laser, for example, is known from prior art for this purpose. After clamping the tool holder to the shank of the main spindle, the main spindle accelerates the shank and the tool holder with cutting tool to the nominal rotational speed and the rotating cutting machining tool is subsequently moved into the measuring laser to determine the actual length. Following this, machining of the workpiece will be started.

Especially, when machining is to be performed at high speeds, the shank of the main spindle heats up over a period of several minutes. As a result, the shank thermally expands in the longitudinal direction and the rotating tool holder with cutting tool clamped thereto is displaced in the longitudinal direction. In addition, speed- and thermally-induced displacement of the shank occurs in the axial direction with respect to the bearing points of the shank. This results in undesirable inaccuracies during machining, since the process extends over a longer period of time following measurement in the measuring laser. In addition, the heat from the shank of the main spindle enters the tool holder through the clamping point, so that the tool holder will also be heated to become thermally elongated. This results in additional displacement of the cutting tool and thus in additional inaccuracies during machining. Since this process takes several minutes and the measurement of the length of the cutting tool will be performed directly after clamping the tool holder to the shank of the main spindle, the thermal and speed-related displacement of the cutting tool occurs during machining of the workpiece and leads to inaccuracies.

In practice, for high-precision machining, warm-up waiting times are provided after each change of a cutting tool until the main spindle, the tool holder and the cutting tool are in thermal equilibrium. It is only then that the length is measured in the measuring laser, and only then that machining starts. The waiting time until such thermal equilibrium is reached may require several minutes and therefore is undesirable, especially if machining time is only short when using the applicable cutting tool.

It is therefore the object of the present invention to provide a machining tool and a method of operating a machining tool, having a simple structure and simple, inexpensive manufacturability, in which high-precision machining of workpieces is possible without having to wait for preceding warm-up times.

This object will be achieved by a machining tool having the features of claim 1 and a method having the features of claim 13. The respective subclaims show preferred further embodiments of the invention.

The machining tool according to the invention having the features of claim 1 has the advantage that no warm-up periods are required to be added for high-precision machining of workpieces, but machining of a workpiece is possible immediately after starting the machining tool or changing a tool. According to the invention, this will be achieved by the fact that thermal and rotational speed-related displacements of a driven shank of a main spindle and a tool holder with cutting tool can be compensated and incorporated into a control unit which is configured to preset a tool path during machining of the workpiece. Herein, the machining tool comprises a main spindle with a driven shank and a tool holder which can be clamped into the shank and in which a cutting tool is arranged. Furthermore, a distance sensor is provided for determining a distance of the shank of the main spindle to a reference point. The control unit is configured to perform compensation of the tool path during machining of the workpiece based on elongation and displacement of the shank and elongation of the tool holder holding the cutting tool. Elongation and displacement of the shank is thus determined based on the distance determined with the distance sensor and elongation of the tool holder with cutting tool is determined based on a rotational speed of the shank. Based on the two input variables of the rotational speed of the shank and the distance determined with the distance sensor, the control unit can thus compensate for the tool path of the cutting tool during machining of a workpiece. Preferably, the values for the rotational speed and the distance are continuously recorded and fed to the control unit, so that continuous adaptation of the tool path of the cutting tool is possible. The distance sensor is preferably a highly accurate distance sensor and especially a distance sensor for contactless measurement, e.g. an eddy-current sensor.

Elongation of the tool holder with cutting tool is determined based on the rotational speed of the shank, because the elongation of the tool holder with cutting tool is caused by temperature change of the shank of the main spindle, which in turn is speed-dependent due to friction in a bearing and/or a temperature increase of a spindle motor often arranged close to the shank for driving it. This speed-dependent temperature increase of the shank of the main spindle causes the tool holder clamped to the shank of the main spindle to also heat up due to heat conduction and expand in the axial direction. Thus, displacement of the cutting tool can be detected and incorporated by adding up
a) the thermal load and elongation based on the rotational speed and the displacement of the shank based on the distance determined with the distance sensor, and
b) the speed-dependent elongation of the tool holder with cutting tool based on the speed of the shank.

Furthermore, by detecting the rotational speed of the shank of the main spindle, the fact that rotation of the shank with the tool holder and the cutting tool held thereon resulting in cooling of the tool holder heated by heat conduction from the shank of the main spindle by convection may also be incorporated. Cooling capacity by convection increases when increasing the rotational speed. Therefore, especially using a preferably cyclic elongation and displacement determination of the shank and the elongation of the tool holder holding the cutting tool, the highly accurate machining of the workpiece can be ensured.

The distance sensor is preferably arranged in the main spindle near the interface to the clamping of the tool holder or outside the main spindle by means of a separate holder.

Still preferably, the surface to be measured on the shank of the main spindle, which is used to determine the distance using the distance sensor, is perpendicular to a center axis X-X of the shank of the main spindle. However, it is also possible, for example, to perform measurements on inclined surfaces and to calculate an axial displacement of the shank accordingly.

Particularly preferably, the distance sensor is arranged such that measurement of the distance is preferably performed at one end of the shank close to the clamping point for the tool holder in order to detect the displacement of the interface between the shank of the main spindle and the tool holder as accurately as possible.

Still preferably, the machining tool comprises a measuring device, especially a measuring laser, which determines a length of the tool holder with cutting tool before a start of machining. The control unit is configured to determine elongation and displacement of the shank and elongation of the tool holder with cutting tool, based on the value measured by the measuring device as a reference point. The value measured using the measuring device will thus be the zero point for determining elongation and displacement of the shank and tool holder with cutting tool.

An even more precise determination of elongation and displacement of the shank of the main spindle and the tool holder with cutting tool will be achieved if the control unit is configured to determine a temperature of the shank at a clamping point of the tool holder with cutting tool in the main spindle based on distance values of the distance sensor and the rotational speed of the shank. Elongation of the tool holder with cutting tool will subsequently be determined therefrom as well as from the rotational speed of the shank.

Alternatively or additionally, a temperature of the shank at the clamping interface of the tool holder and from this the elongation of the tool holder with cutting tool can also be determined based on a rotational speed curve of the shank over time and/or a curve of the distance values that are recorded by the distance sensor over time.

Still preferably, the control unit is configured to determine elongation of the tool holder with cutting tool based on a first tool holder temperature before start of machining. By detecting the first temperature of the tool holder prior to start of machining, accuracy in compensating the tool path can further be improved.

Preferably, the control unit is configured to determine the first temperature of the tool holder with cutting tool prior to start of machining from a holding time of the tool holder in the tool changer since the last clamping on the shank of the main spindle. In this way, different temperatures of the tool holder in the tool changer can be detected in a simple and easy manner. Still preferably or additionally, a first temperature sensor is provided, which determines the first temperature of the tool holder prior to start of machining, wherein the control unit is configured for determining elongation of the tool holder with cutting tool based on the first temperature prior to start of machining. The first temperature can be measured directly at the tool holder in a non-contact manner or with the use of a contacting probe or the like.

For this purpose, the temperature sensor is preferably arranged in the tool changer. The temperature can be measured in a contactless manner, for example using an infrared sensor. In this case, it is also possible that the temperature of the tool holder is preferably measured directly after clamping the tool holder onto the main spindle, so that a temperature sensor in the tool changer may be occasionally be omitted.

Further alternatively, the first temperature sensor is arranged below the main spindle adjacent to the clamping point of the tool holder in the shank.

Preferably, the first temperature sensor is movable by means of a traversing unit in order to measure the first temperature in the vicinity of the clamping point of the tool holder in the main spindle in the clamped state.

According to another preferred embodiment of the present invention, the machining tool further comprises a second temperature sensor which determines a second temperature of the shank. The control unit is configured to determine elongation of the tool holder with cutting tool based on the detected second temperature and/or based on progression of the detected second temperature over time. This enables accurate temperature detection of the shank, which enables transfer of the increasing temperature of the shank to the tool holder via heat conduction and, accordingly, elongation occurs in the axial direction of the tool holder with cutting tool.

Still preferably, the machining tool comprises a third temperature sensor, which is arranged at a bearing of the shank. The third temperature sensor determines a third temperature of the bearing, wherein the control unit is configured to determine a temperature of the shank based on the third temperature of the bearing and/or a course of the third temperature of the bearing over time and to determine the elongation of the tool holder with cutting tool therefrom. Thus, the bearing temperature can additionally be detected as another input variable, from which the temperature of the shank can be derived, which in turn enables determination of the axial elongation of the tool holder with cutting tool.

Still preferably, the machining tool comprises a fourth temperature sensor, which detects a fourth temperature of a working space of the machining tool. The control unit is configured to determine elongation of the tool holder with cutting tool based on the fourth temperature of the workspace and/or variation of the fourth temperature of the workspace over time. By detecting the workspace temperature, it is possible to realize even more accurate compensation of the tool path. This is especially important if, for example, the tool changer is arranged at a relatively large distance from the workspace or, if necessary, in a separate cabinet or the like, outside the workspace, where a temperature different from that in the workspace prevails.

Another more accurate compensation of the tool path is possible with the control unit of the machining tool to be configured to determine elongation of the tool holder with cutting tool based on a geometry of the tool holder and/or based on a geometry of the cutting tool. Basically, in a thermal steady state during machining, the temperature of the tool holder is highest at the clamping point on the shank of the main spindle. While increasing the distance from the clamping point, the temperature of the tool holder decreases due to rotation-induced convection cooling. This effect is also different for different geometries of tool holders, so that the additional input variable of the geometry of the tool holder and/or the cutting tool can further improve the machining accuracy.

According to another preferred embodiment of the invention, the machining tool further comprises a fifth temperature sensor, which detects a fifth temperature of the distance sensor and/or a time history of the fifth temperature of the distance sensor. The control unit is configured to determine a temperature of the shank and therefrom elongation of the tool holder with cutting tool based on the fifth temperature sensor of the distance sensor. As the distance sensor is arranged very close to the shank of the main spindle, an accurate temperature of the shank of the main spindle can be detected and processed in the control unit.

Preferably, the control unit is configured as a learning system, especially to also enable elongation and displacement determination of the shank and/or the elongation of the tool holder with cutting tool from data history.

Preferably, the control unit has a memory in which standardized geometries for tool holders and/or cutting tools are deposited. A machining tool operator can then enter this additional input variable for determining elongation and displacement of the shaft and/or elongation of the tool holder with cutting tool into the control unit simply by selecting the appropriate standardized geometry.

Furthermore, the present invention relates to a method for operating a machining tool having the features of claim 13. The method is to adjust a tool path during operation of the machining tool when machining a workpiece, using an elongation and displacement of the shank and an elongation of the tool holder with cutting tool. Elongation and displacement of the shank is determined based on distance values of the distance sensor and elongation of the tool holder with cutting tool is determined based on a rotational speed of the shank. Thus, the advantages illustrated above regarding the machining tool according to the invention can be obtained.

Preferably, the method according to the invention will be performed such that

a first temperature of the tool holder is determined prior to the start of machining from a holding time of the tool holder in the tool changer ever since the last clamping on the shank of the main spindle and/or
the first temperature of the tool holder is determined prior to start of machining using a first temperature sensor, and elongation of the tool holder with cutting tool is determined based on the first temperature of the tool holder prior to start of machining, and/or
a second temperature of the shank is determined using a second temperature sensor and elongation of the tool holder with cutting tool is determined based on the second temperature detected and/or is determined from progression of the second temperature over time, and/or
a third temperature of a bearing in which the shank is mounted is determined using a third temperature sensor and the temperature of the shank is determined, and elongation of the tool holder with cutting tool is determined therefrom based on the third temperature of the bearing and/or based on a temperature profile of the third temperature of the bearing over time, and/or
based on the values of the distance sensor and the rotational speed of the shaft, a temperature of the shaft is determined, and elongation of the tool holder with cutting tool is determined based on the temperature of the shaft determined in this way and the rotational speed, and/or
based on the course of the distance values of the distance sensor over time, a temperature of the shaft and therefrom an elongation of the tool holder with cutting tool is determined and/or
based on a rotational speed profile of the shaft over time, an elongation of the tool holder with cutting tool is determined, and/or
based on a fourth temperature of a working space of the machining tool and/or based on a course of the fourth temperature of the working space over time, elongation of the tool holder with cutting tool is determined, and/or
based on a fifth temperature of the distance sensor, a temperature of the shaft and therefrom elongation of the tool holder with cutting tool is determined.

Preferably, the method according to the invention for elongation and displacement determining the shank and/or the elongation of the tool holder with cutting tool incorporates data history of previous machining operations in which the two elongations and the displacement of the shank with the tool holder with cutting tool were determined.

Still preferably, the method according to the invention is continuously carried out during machining operation of a workpiece to enable continuous adaptation of the tool path during the machining of the workpiece. Moreover, it is possible for the control unit to execute a training operation in the times when the machining tool is not being used for machining to continuously repeat elongation and displacement determination of the shank and elongation of the tool holder with cutting tool and to refine or correct elongation and displacement values. This is especially an advantage in that if a bearing of the main spindle changes in its behavior over a lifetime of the machining tool, additional training of the control unit and/or individual parameters used to determine elongation and displacement of the shank and/or the elongation of the tool holder with cutting tool is performed.

Hereinafter, a preferred example embodiment of the invention will be described in detail while reference will be made to the accompanying drawing, wherein:

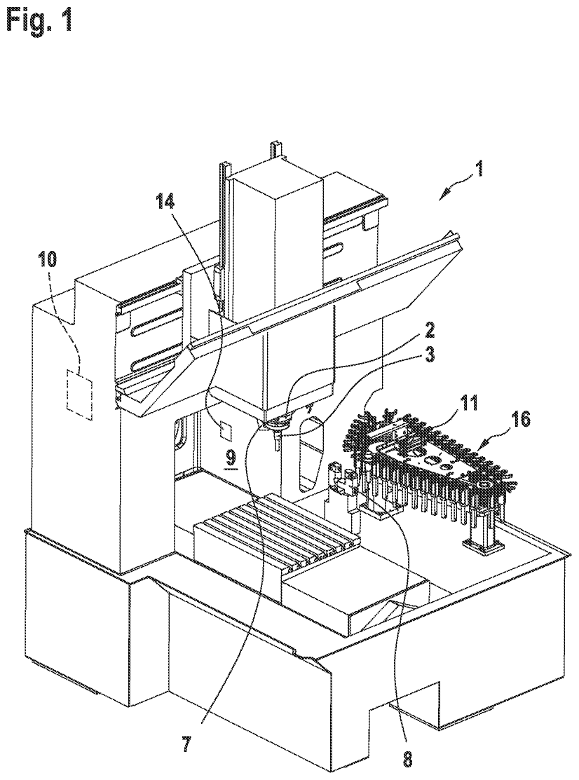

FIG. 1 is a schematic, perspective view of a machining tool according to a preferred example embodiment of the invention,

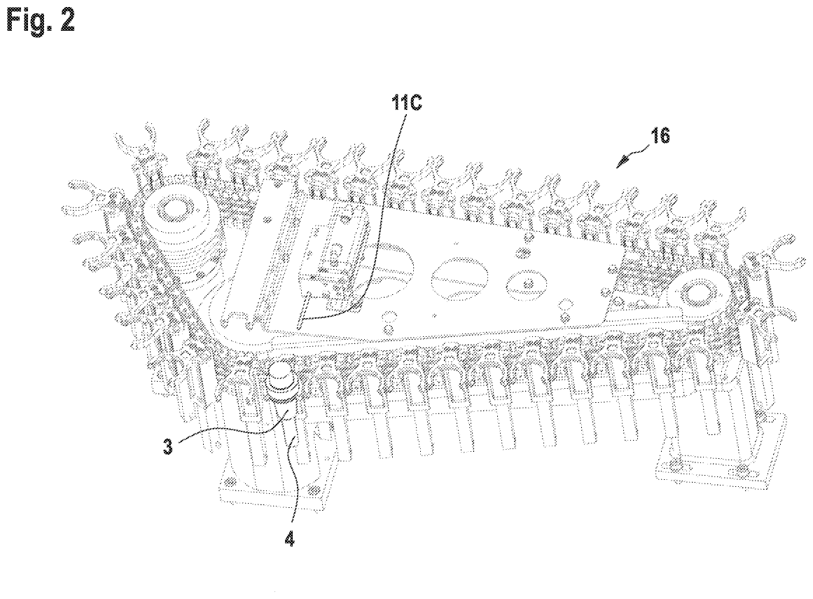

FIG. 2 is a schematic, perspective view of a tool changer of the machining tool of FIG. 1 with a temperature sensor in a first position,

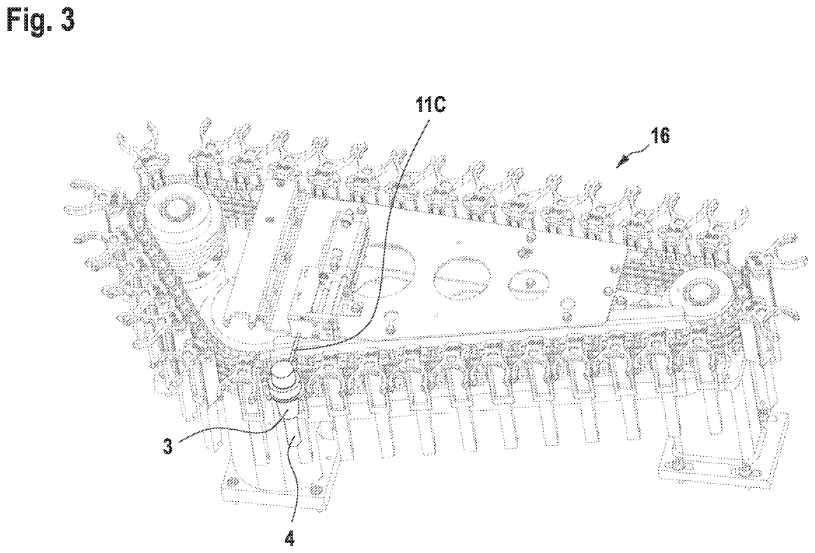

FIG. 3 is a schematic, perspective view of the tool changer of FIG. 2 with the temperature sensor in a second position,

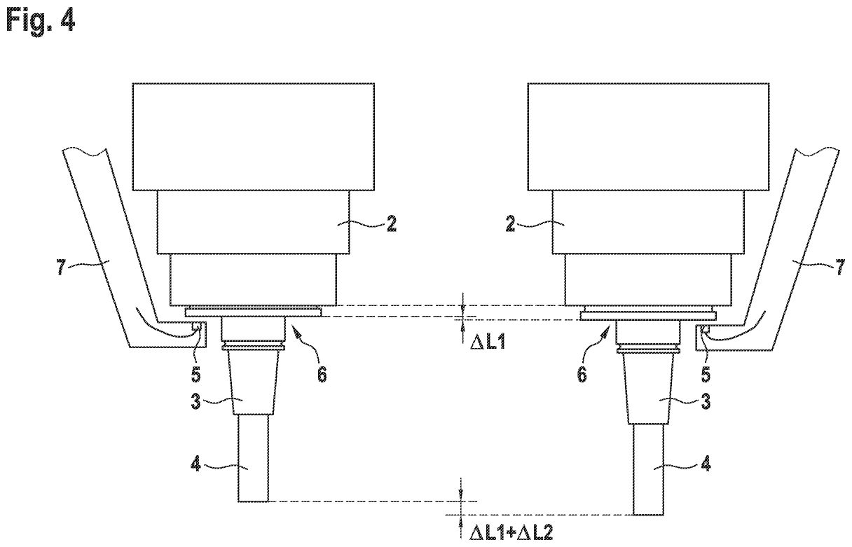

FIG. 4 is a schematic comparative view of the elongation and displacement of a shank and the elongation of a tool holder with cutting tool of the machining tool of FIG. 1,

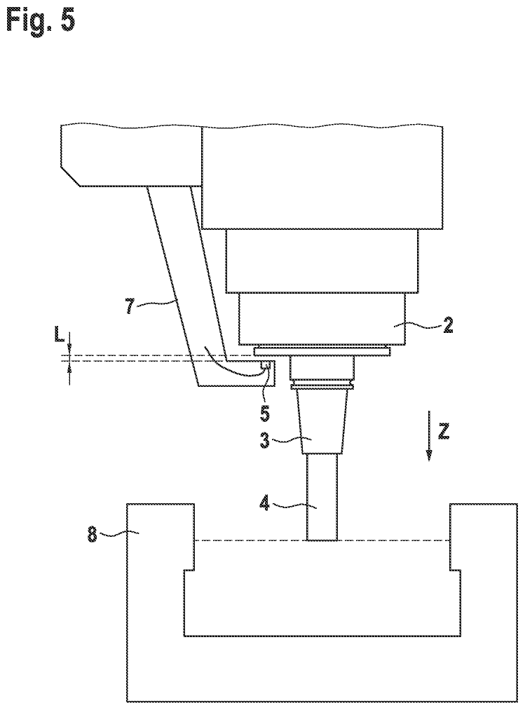

FIG. 5 is a schematic lateral view of the main spindle of the machining tool of FIG. 1 during a measuring operation in a measuring device, and

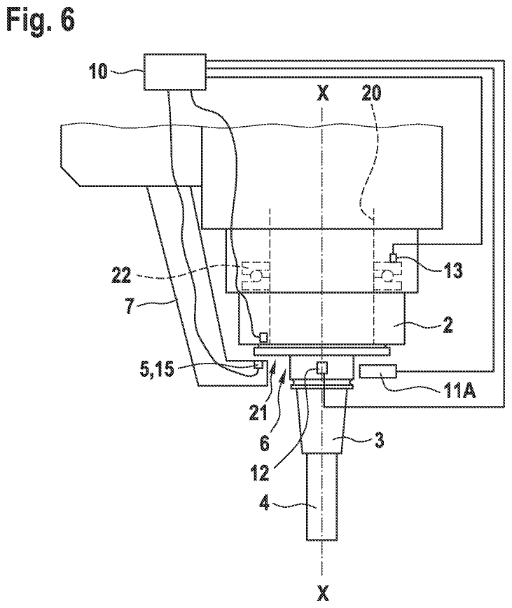

FIG. 6 is a schematic view of the main spindle with tool holder of the machining tool of FIG. 1.

In the following, a preferred example embodiment of the invention will be described in detail, while reference will be made to FIGS. 1 to 6.

As may be seen from FIG. 1, the machining tool 1 for machining a workpiece comprises a main spindle 2 and a tool holder 3, which is clamped into a driven shank 20 (cf. FIG. 6) of the main spindle 2. The tool holder 3 is used for mounting a cutting tool 4, for example a milling cutter, used to machine a workpiece (not shown) on a machining table.

The machining tool 1, in a working space 9, further comprises a tool changer 15 in which a plurality of tool holders 3 holding cutting tools 4 are arranged and which can provide various tools in a rotating manner. The tool changer may be seen in detail from FIGS. 2 and 3.

As may further be seen from FIGS. 5 and 6, the machining tool 1 further comprises a distance sensor 5 for determining a distance L of the shank 20 of the main spindle 2 to a reference point. In this example embodiment, the reference point is located directly on a surface of the distance sensor 5.

The machining tool 1 further comprises a control unit 10. The control unit 10 is configured to perform compensation of the tool path during machining of the workpiece, based on a first elongation and displacement ΔL1 of the shank 20 and a second elongation ΔL2 of the tool holder 3 with cutting tool 4. Thus, by incorporating both elongations and displacements ΔL1 and ΔL2, high-precision machining of a workpiece may be realized.

The first elongation and displacement ΔL1 of the shank 20 is based on the distance L determined by the distance sensor 5. The second elongation ΔL2 of the tool holder 3 holding the cutting tool 4 is based on a rotational speed of the shank 20. The rotational speed of the shank 20 can be determined by methods known from prior art, e.g. a rotational speed sensor, or rotational speed is a value already known for the control unit 10. It should be noted that basically, the control unit 10 may be a separate control unit or may also be integrated into a main control unit of the machining tool.

Thus, thermal-induced and speed-induced elongation and displacement of the shank 20 of the main spindle 2 may contactlessly be measured using the distance sensor 5. As may be seen from FIG. 6, the distance sensor 5 is arranged such that a distance L of the shank 20 from a shank end 21 may be determined. The shank end 21 is perpendicular to a center axis X-X of the shank 20.

The distance sensor 5 is arranged using a holder 7 below the main spindle 2, adjacent to a clamping point 6 of the tool holder 3 in the shank 20.

The elongation ΔL2 of the tool holder 3 holding the cutting tool 4 is determined based on the rotational speed of the shank 20. This allows the additional second elongation of the tool holder 3 holding cutting tool 4 to be detected in addition to the first elongation and displacement ΔL1 of the shank 20. The second elongation ΔL2 of the tool holder 3 holding the cutting tool 4 is generated by heat conduction from the shank 20 to the tool holder 3, causing the tool holder 3 and the cutting tool 4 to expand in the axial direction. This results in additional displacement of the end of the cutting tool 4, which cannot be detected by the distance sensor 5, since it only detects the axial elongation and displacement of the shank 20 of the main spindle 2. Elongation ΔL2 of the tool holder 3 holding the cutting tool 4 essentially depend on the rotational speed of the shank 20, the rotation also generating a cooling effect by convection at the tool holder 3 holding the cutting tool 4.

Based on the distance value L and the rotational speed of the shank 20, the control unit 10 can now determine the first and second elongation and displacement ΔL1 and ΔL2, enabling appropriate compensation of the tool path of the cutting tool 4.

To increase compensation accuracy of the tool path during machining, the machining tool 1 further comprises a first temperature sensor 11A, which, as may be seen from FIG. 6, is arranged below the main spindle 2 adjacent to the clamping point 6 of the tool holder 3 in the shank 20. The first temperature sensor 11A determines a first temperature T1 of the tool holder 3 before start of machining. The control unit is configured to additionally determine the elongation ΔL2 of the tool holder 3 holding the cutting tool 4, based on the first temperature T1. Of course, the first temperature sensor 11A may also continuously determine the first temperature T1 of the tool holder 3 during machining, and the control unit 10 may use the temperature values measured to appropriately compensate the tool path of the cutting tool 4.

It should be noted that the first temperature sensor 11A may also be movably arranged under the main spindle 2 in the vicinity of the clamping point 6 of the tool holder 3 in the main spindle 2 for measuring the first temperature T1 on a travel unit that is not shown.

Alternatively or additionally, the machining tool 1 comprises another first temperature sensor 11C in the tool changer 15 (cf. FIGS. 2 and 3) to measure the first temperature T1 of the tool holder 3 holding the cutting tool 4 prior to clamping the tool holder 3 to the shank 20.

Accuracy of the determination of the second elongation ΔL2 of the tool holder 3 holding the cutting tool 4 can be further improved by detecting additional temperatures. As may be seen from FIG. 6, a second temperature sensor 12 is provided which determines a second temperature T2 of the shank 20, wherein the control unit 10 is configured to additionally or alternatively determine the second elongation ΔL2 of the tool holder 3 with cutting tool 4 based on the detected second temperature T2. Thus, the elongation ΔL2 of the tool holder 3 with cutting tool 4 can be determined more precisely based on the rotational speed and the second temperature T2.

As may be seen from FIG. 6, a third temperature sensor 13 is arranged on a bearing 22 for supporting the shank 20. The third temperature sensor 13 detects a third temperature T3 of the bearing 22, wherein the control unit 10 is configured to additionally or alternatively determine a temperature of the shank 20 and therefrom an elongation ΔL2 of the tool holder 3 with cutting tool 4 based on the third temperature T3. Thus, the accuracy of the elongation of the tool holder 3 with cutting tool 4 may even further be improved.

As can be seen from FIG. 1, a fourth temperature sensor 14 is provided, which detects a fourth temperature T4 of the working space 9 of the machining tool 1. The control unit 10 is configured to additionally or alternatively determine the second elongation ΔL2 of the tool holder 3 with cutting tool 4 based on the fourth temperature T4 of the working space 9. This may further improve accuracy in compensating the tool path.

A fifth temperature sensor 15 is integrated into the distance sensor 5. The fifth temperature sensor 15 detects a fifth temperature T5 of the distance sensor 5, wherein the control unit 10 is configured to determine the elongation ΔL2 of the tool holder 3 holding the cutting tool 4 additionally or alternatively on the fifth temperature T5.

With respect to the first to fifth temperatures detected, it should be noted that the control unit 10 is configured to determine both the absolute values of the detected temperatures and additionally or alternatively, the temperature curves over time for determining the second elongation ΔL2 of the tool holder 3 with cutting tool 4.

Furthermore, the control unit 10 is arranged for processing data history input variables and to determine the first and second elongation and displacement of the shank 20 and the tool holder 3 with cutting tool 4.

Thus, the first elongation and displacement ΔL1 of the shank 20 can be determined based on distance values L of the distance sensor 5 and the second elongation ΔL2 of the tool holder 3 with cutting tool 4 can be determined based on a rotational speed of the shank 20 and, in this embodiment example, additionally or alternatively based on the first to fifth temperatures T1, T2, T3, T4 and T5. In this way, in particular the second elongation ΔL2 of the tool holder 3 with cutting tool 4 can be determined with high precision and incorporated into the machining process.

FIG. 4 schematically shows the first and second elongation and displacement ΔL1 and ΔL2 of the shank 20 and the tool holder 3 with cutting tool 4. The left-hand illustration shows the main spindle 2 holding the tool holder 3 and the cutting tool 4, for which no elongation and displacement due to thermal and speed effects has yet occurred. The right-hand illustration schematically shows a first elongation and displacement ΔL1 of the shank 20 and a second elongation ΔL2 of the tool holder 3 with cutting tool 4. The total of the first and second elongations and displacements ΔL1 plus ΔL2 results in total elongation and displacement of the shank 20 and the tool holder 3 with cutting tool 4 in the axial direction X-X.

### LIST OF REFERENCE NUMBERS

1 Machining tool
2 Main spindle
3 Tool holder
4 Cutting tool
5 Distance sensor
6 Clamping point of the tool holder in the main spindle
7 Tool holder
8 Measuring device
9 Working area
10 Control unit
11 First temperature sensor
11A First temperature sensor below main spindle
11C First temperature sensor in tool changer
12 Second temperature sensor
13 Third temperature sensor
14 Fourth temperature sensor
15 Fifth temperature sensor
16 Tool changer

### 20 Shank

### 21 Shank end

### 22 Bearing

L Distance shank-reference measuring point
ΔL1 Elongation and displacement of the shank
ΔL2 Elongation of tool holder with cutting tool
T1 through T5 First through fifth temperature
X-X Rotational axis
Z Vertical direction

1. A machining tool for machining a workpiece, comprising:
a main spindle with a driven shank,
a tool holder which can be clamped into the shank,
a cutting tool which is arranged on the tool holder,
a distance sensor for determining a distance of the shank of the main spindle to a reference point, and
a control unit which is arranged to perform compensation of the tool path when machining the workpiece based on an elongation and displacement of the shank and an elongation of the tool holder with cutting tool,
wherein the elongation and displacement of the shank is determined based on the distance determined with the distance sensor, and
wherein the elongation of the tool holder by the cutting tool is determined based on a rotational speed of the shank.

2. The machining tool according to claim 1, further comprising a measuring device, in particular a measuring laser, which determines a length of the tool holder using the cutting tool before start of machining, wherein the control unit is configured to determine the elongation and displacement of the shank and the elongation of the tool holder holding the cutting tool based on the value measured using the measuring device.

3. The machining tool according to claim 1, wherein the control unit is configured to determine a temperature of the shank at a clamping point of the tool holder in the main spindle based on distance values of the distance sensor and on the rotational speed of the shank and therefrom to determine the elongation of the tool holder holding the cutting tool and/or
wherein the control unit is configured to determine a temperature of the shank based on a speed curve of the shank over time and/or the curve of the distance values of the distance sensor over time and therefrom to determine the elongation of the tool holder using the cutting tool.

4. The machining tool according to claim 1, wherein the control unit is arranged to determine the elongation of the tool holder using the cutting tool based on a first temperature of the tool holder holding the cutting tool prior to the start of machining.

5. The machining tool according to claim 4, wherein the control unit is configured to determine the first temperature of the tool holder with cutting tool prior to start of machining from a holding time of the tool holder with cutting tool in the tool changer ever since the last clamping on the shank main spindle.

6. The machining tool according to claim 4, further comprising a first temperature sensor (11A, 11C) which determines a first temperature of the tool holder with cutting tool prior to start of machining, wherein the control unit is arranged to determine the elongation of the tool holder holding the cutting tool based on the first temperature before start of machining.

7. The machining tool according to claim 6, wherein the first temperature sensor is arranged below the main spindle adjacent to the clamping point of the tool holder in the shank and/or
wherein the first temperature sensor is movable below the main spindle near the clamping point of the tool holder in the main spindle for measuring the first temperature of the tool holder clamped on the shank using a travel unit and/or
wherein the first temperature sensor is arranged in the tool changer of the machining tool to measure the first temperature of the tool holder using the cutting tool prior to clamping the tool holder onto the shank.

8. The machining tool according to claim 1, further comprising a second temperature sensor, which determines a second temperature of the shank, wherein the control unit is arranged to determine the elongation of the tool holder holding the cutting tool based on the second temperature detected and/or on a course of the second temperature detected over time.

9. The machining tool according to claim 1, further comprising a third temperature sensor which is arranged on a bearing of the shank and which determines a third temperature of the bearing, wherein the control unit is configured to determine a temperature of the shank based on the third temperature of the bearing and/or a course of the third temperature of the bearing over time and therefrom to determine the elongation of the tool holder holding the cutting tool

10. The machining tool according to claim 1, further comprising a fourth temperature sensor, which detects a fourth temperature of a working space of the machining tool, wherein the control unit is configured to determine elongation of the tool holder holding the cutting tool based on the fourth temperature of the working space and/or a course of the fourth temperature of the working space over time.

11. The machining tool according to claim 1, wherein the control unit is configured to determine the elongation of the tool holder holding the cutting tool based on a geometry of the tool holder, and/or
wherein the control unit is configured to determine the elongation of the tool holder holding the cutting tool, based on a geometry of the cutting tool.

12. The machining tool according to claim 1, further comprising a fifth temperature sensor, which detects a fifth temperature of the distance sensor and/or a time course of the fifth temperature of the distance sensor, wherein the control unit is configured to determine a temperature of the shank and therefrom the elongation of the tool holder with cutting tool, based on the fifth temperature of the distance sensor.

13. A method for operating a machining tool which comprises a main spindle with a shank, a tool holder which can be clamped into the main spindle and a cutting tool arranged on the tool holder, as well as a distance sensor for determining a distance of the shank of the main spindle from a reference point,
wherein, during operation of the machining tool, the elongation and displacement of the shank and the elongation of the tool holder with cutting tool is incorporated to compensate for the tool path during machining of the workpiece,
wherein the elongation and displacement of the shank is determined based on distance values of the distance sensor, and
wherein the elongation of the tool holder holding the cutting tool is determined based on a rotational speed of the shank.

14. The method according to claim 13, wherein a first temperature of the tool holder holding the cutting tool prior to the start of machining is determined from a holding time of the tool holder with cutting tool in the tool changer since the last clamping on the shank of the main spindle and/or the first temperature of the tool holder with cutting tool prior to the start of machining is determined using a first temperature sensor, and the elongation of the tool holder holding the cutting tool is determined based on the first temperature of the tool holder with cutting tool prior to the start of machining, and/or
wherein a second temperature of the shank is determined using a second temperature sensor and the elongation of the tool holder holding the cutting tool is determined based on the second temperature detected and/or is determined from a progression of the second temperature over time, and/or
wherein a third temperature of the bearing supporting the shank is determined over time using a third temperature sensor and a temperature of the shank and hence the elongation of the tool holder with cutting tool is determined based on the third temperature of the bearing and/or a temperature progression of the third temperature of the bearing, and/or
wherein, based on the values of the distance sensor and the rotational speed of the shank, a temperature of the shank is determined and based on the temperature of the shank determined therefrom, the elongation of the tool holder with cutting tool is determined, and/or
wherein, based on the course of the distance values of the distance sensor over time, the elongation of the tool holder holding the cutting tool is determined and/or
wherein the elongation of the tool holder with cutting tool is determined over time based on a rotational speed curve of the shank, and/or
wherein the elongation of the tool holder holding the cutting tool is determined based on a fourth temperature of a working chamber of the machining tool and/or based on a course of the fourth temperature of the working chamber over time, and/or
wherein, based on a fifth temperature of the distance sensor, a temperature of the shank is determined, wherefrom the elongation of the tool holder holding the cutting tool is determined.

15. The method according to claim 13 or 14, wherein for determining the elongation and displacement of the shank and/or the elongation of the tool holder with cutting tool, data history of previous machining operations, in which history the elongation and displacement of the shank and/or the elongation of the tool holder holding the cutting tool were determined, are incorporated.
